(19) United States
(12) Patent Application Publication
(10) Pub. No.: US 2026/0083614 A1
(43) Pub. Date: Mar. 26, 2026

(54) DESKTOP UPPER LIMB REHABILITATION ROBOT

(71) Applicant: Futronics (NA) Corporation, Pasadena, CA (US)

(72) Inventors: QIANSHAN LI, Pasadena, CA (US); Shixun Chen, Pasadena, CA (US); Wenda Xu, Pasadena, CA (US); Fangyun Zhao, Pasadena, CA (US); Chengkun Zhang, Pasadena, CA (US); Huan Tan, Pasadena, CA (US)

(21) Appl. No.: 18/895,448

(22) Filed: Sep. 25, 2024

(51) Int. Cl. A61H 1/02

(52) U.S. Cl. CPC A61H 1/0274; A61H 2201/0119; A61H 2201/0192

(57) ABSTRACT

A desktop upper limb rehabilitation robot includes: a housing having a bottom plate; a clamping member comprising a main body slidably connected to the bottom plate and a jaw connected to the main body, the main body defining a threaded hole, the threaded hole and the jaw located at opposite sides of the bottom plate; a threaded rod structure comprising a threaded rod, the threaded rod comprising an end rotatably connected to and abutting against the bottom plate, the threaded rod threadedly engaged with the threaded hole, and the threaded rod configured to rotate with respect to the bottom plate so as to drive the main body to move with respect to the bottom plate, allowing the jaw to move together with the main body to a desired position where an edge of a desk is sandwiched between the bottom plate and the jaw.

### TECHNICAL FIELD

The present disclosure generally relates to robots, and in particular relates to a desktop/desk-mounted upper limb rehabilitation robot.

### BACKGROUND

A desktop upper limb rehabilitation robot can assist elderly individuals or patients with mobility impairments in rehabilitation training, preventing muscle atrophy and helping to restore upper limb mobility. The handle is set on the desktop through a translation mechanism, and as the mechanism operates, it drives the hand rest to move, thereby guiding the movement of the upper limb.

To maintain its stability, the desktop upper limb rehabilitation robot typically needs to be securely mounted on the desktop. The current method of fixation primarily involves securing the robot to the desktop using screws, which requires drilling threaded holes in the desktop, making it unsuitable for all types of desks.

Therefore, there is a need to a desktop upper limb rehabilitation robot to overcome the above-mentioned problem.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of a desktop upper limb rehabilitation robot attached to a desktop according to one embodiment.

FIG. 2 is an isometric view of an assembly including a bottom plate, a clamping member and a threaded rod structure of the robot.

FIG. 3 is a front partial view of the assembly of FIG. 2.

FIG. 4 is a planar cross-sectional view of the assembly of FIG. 2.

FIG. 5 is another planar cross-sectional view of the assembly of FIG. 2.

FIG. 6 is an isometric view of the clamping member of FIG. 2.

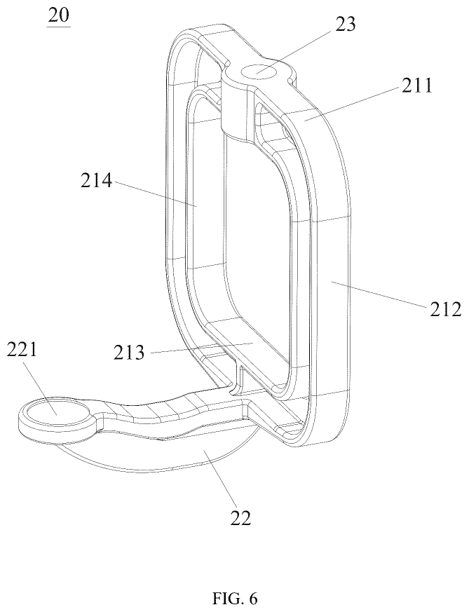

FIG. 7 is similar to FIG. 5, with a desktop omitted.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

A desktop upper limb rehabilitation robot can assist elderly individuals or patients with mobility impairments in rehabilitation training, preventing muscle atrophy and helping to restore upper limb mobility. The handle is set on the desktop through a translation mechanism, and as the mechanism operates, it drives the hand rest to move, thereby guiding the movement of the upper limb.

To maintain its stability, the desktop upper limb rehabilitation robot typically needs to be securely mounted on the desktop. The current method of fixation primarily involves securing the robot to the desktop using screws, which requires drilling threaded holes in the desktop, making it unsuitable for all types of desks.

To address the aforementioned technical issue, the present disclosure proposes a desktop upper limb rehabilitation robot 100. This robot includes a housing 101 having a bottom plate 10, a threaded rod structure 30, and a clamping member 20. The clamping member 20 passes through the bottom plate 10, and the threaded rod structure 30 is threadedly connected to the clamping member 20. The clamping member 20 and threaded rod structure 30 are integrated to the bottom plate 10, allowing the robot to be mounted directly onto a desktop 200 using a clamp structure. No connection holes are required in the desktop 200, making it suitable for most types of desktops.

The desktop upper limb rehabilitation robot 100 provided in the embodiments of the present disclosure is now described.

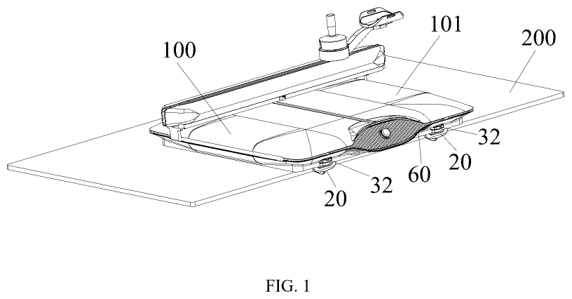

Referring to FIGS. 1-4, in one embodiment, the bottom plate 10 is part of the housing 101 and is a flat plate. The threaded rod structure 30 and the clamping member 20 are mounted on the bottom plate 10, meaning that the threaded rod structure 30 and the clamping member 20 are connected to the housing 101, providing a clamping structure that is integrated to the robot, which allows the desktop upper limb rehabilitation robot 100 to be securely attached to the desktop 200 without the need for mounting holes in the desktop 200. The housing 101 defines a chamber, where the robot's main functional components can be housed.

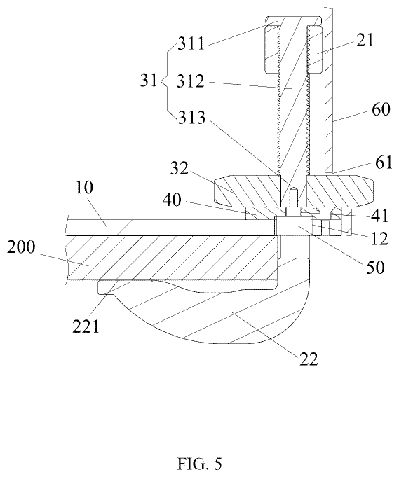

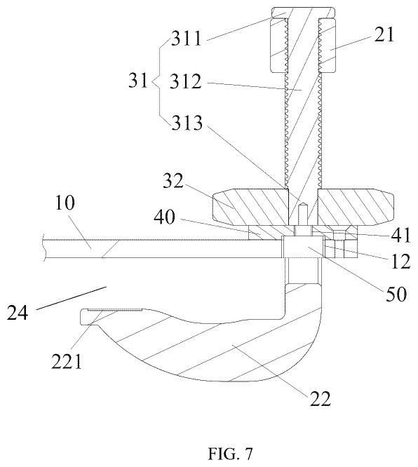

The clamping member 20 passes through the bottom plate 10 and is capable of moving linearly with respect to the bottom plate 10, meaning that the clamping member 20 is slidably connected to the bottom plate 10. Specifically, the clamping member 20 may include a main body 21 and a jaw 22 connected to the main body 21. The main body 21 defines a threaded hole 23. The threaded hole 23 and the jaw 22 are located on opposite sides of the bottom plate 10. The bottom plate 10 has a first side (i.e., upper side) and a second side (i.e., lower side) that are oppositely positioned. As shown in FIG. 5, the threaded hole 23 is above the bottom plate 10, while the jaw 22 is below the bottom plate 20. That is, the threaded hole 23 is located at the first side of the bottom plate 10. The threaded rod structure 30 passes through the threaded hole 23. The jaw 22 faces the second side of the bottom plate 10 and a gap 24 (see FIG. 7) can be formed between the jaw 22 and the bottom plate 10, allowing an edge of the desktop 200 to be sandwiched between the jaw 22 and the bottom plate 10. In other words, the jaw 22 and the bottom plate 10 can form a clamp structure that can detachably connect the robot 100 to the desktop 200.

The threaded rod structure 30 is located at the first side of the bottom plate 10. The threaded rod structure 30 has an external thread so as to be threadedly connected with the threaded hole 23. One end of the threaded rod structure 30 abuts against the first side of the bottom plate 10. The threaded rod structure 30 is rotatable with respect to the bottom plate 10.

When the threaded rod structure 30 is rotated, one end (i.e., lower end) of the threaded rod structure 30 is always in contact with the first side of the bottom plate 10, and the clamping member 20 moves along the lengthwise direction of the threaded rod structure 30 under the restriction and guidance of the bottom plate 10. The jaw 22 moves along the length direction of the threaded rod structure 30 accordingly, so that the distance between the jaw 22 and the second side of the bottom plate 10 can be changed, and an edge of the desktop 200 can be clamped between the jaw 22 and the second side of the bottom plate 10 or the housing 101 can be detached from the desktop 200.

The desktop upper limb rehabilitation robot 100 in the above embodiment includes the bottom plate 10, threaded rod structure 30 and clamping member 20. The bottom plate 10 is part of the housing 101. The clamping member 20 defines a threaded hole 23 and includes a jaw 22. The threaded rod structure 30 is threadedly connected to the clamping member 20. When the threaded rod structure 30 is rotated, the clamping member 20 moves linearly under the restriction of the bottom plate 10, changing the distance between the jaw 22 and the bottom plate 10, so that the edge of a desktop can be clamped between the jaw 22 and the bottom plate 10. The clamping member 20 and the threaded rod structure 30 are installed on the bottom plate 10 of the robot, that is, a clamping structure is integrated into the desktop upper limb rehabilitation robot 100, allowing the robot to be directly attached to the desktop 200.

The bottom plate 10 is usually placed on a support surface (e.g., desktop) and can withstand a certain amount of pressure, and is therefore more suitable for installing the threaded rod structure 30 and the clamping member 20.

In one embodiment, at least a portion of the threaded rod structure 30 and at least a portion of the clamping member 20 are located within the housing 101. In this way, at least a portion of the structure of the clamping structure is located in an inner chamber of the housing 101 and is hidden inside the housing 101, so that the structure of the robot is more integrated and the appearance is more complete.

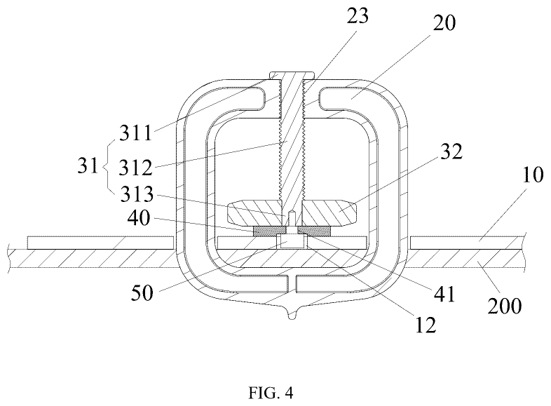

Referring to FIGS. 4 and 5, in one embodiment, the main body 21 passes through the bottom plate 10. The threaded hole 23 is defined in the main body 21 away from the jaw 22. The portion of the main body 21 away from the jaw 22 is located in the inner chamber of the housing 101. The portion of the main body 21 with the threaded hole 23 is located at the first side (i.e., upper side) of the bottom plate 10, and the portion of the main body 21 connected to the jaw 22 is located at the second side of the bottom plate 10. The main body 21 passes through the bottom plate 10, and a corresponding avoidance structure for allowing the main body 21 to pass therethrough is defined in the bottom plate 10. The inner wall of the avoidance structure can guide the main body 21. The portion of the main body 21 with the threaded hole 23 is hidden inside the housing 101.

The clamping member 20 includes the main body 21 and the jaw 22 connected to each other. The threaded hole 23 can be defined in the main body 21, and the main body 21 can be driven to move linearly by rotating the threaded rod structure 30.

In one embodiment, the main body 21 and the jaw 22 are integrally formed. For example, the main body 21 and the jaw 22 can be integrally formed with each other by injection molding or casting.

In one embodiment, the main body 21 and the jaw 22 are formed separately. For example, the main body 21 and the jaw 22 are fixedly connected to each other by a connecting member such as a screw. Alternatively, the main body 21 and the jaw 22 are welded to each other.

In one embodiment, the jaw 22 extends from an end (e.g., lower end) of the main body 21 toward the second side of the bottom plate 10. The jaw 22 has an abutting surface 221, and the abutting surface 221 cooperates with the second side of the bottom plate 10 to clamp the edge of the desktop therebetween. The abutting surface 221 is away from the main body 21, so that the clamping member 20 can cooperate with the bottom plate 10 to clamp objects with a larger area.

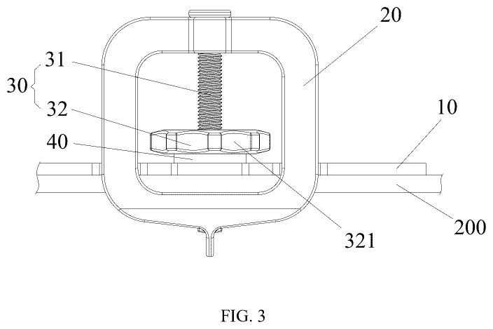

Referring to FIGS. 3-5, in one embodiment, the main body 21 may include a first connecting section 211, a second connecting section 212, a third connecting section 213, and a fourth connecting section 214 that are connected to one another, forming a rectangular ring. The threaded hole is defined in the first connecting section 211. The jaw 22 is connected to the third connecting section 213. The second connecting section 212 and the fourth connecting section 214 passes through the bottom plate 10. Opposite ends of the first connecting section 211 are respectively connected to the upper ends of the second connecting section 212 and the fourth connecting section 214, and opposite ends of the third connecting section 211 are respectively connected to the lower ends of the second connecting section 212 and the fourth connecting section 214. The first connecting section 211 is located at the first side (i.e., upper side) of the bottom plate 10, the third connecting section 213 is located at the second side (i.e., lower side) of the bottom plate 10, and the second connecting section 212 and the fourth connecting section 214 both passes through the bottom plate 10.

The main body 21 is a rectangular ring, which can reduce the amount of raw materials used for the main body 21. Moreover, the second connecting section 212 and the fourth connecting section 214 both pass through the bottom plate 10, so the bottom plate 10 strengthens the guiding effect for the main body 21, and the sliding of the main body 21 is more stable.

In one embodiment, the threaded hole 23 is arranged in the middle of the first connecting section 211, so that the force on the main body 21 can be more balanced and the movement of the sliding frame 21 can be more stable.

In some embodiments, the first connecting section 211 and the third connecting section 213 are parallel to each other, and the second connecting section 212 and the fourth connecting section 214 are parallel to each other, forming a rectangular ring. The structural shape of the main body 21 is regular, easy to process, and has high structural strength.

In one embodiment, referring to FIG. 1, one or more notches 11 are provided at an edge of the bottom plate 10, and the main body 21 passes through the notches 11. Alternatively, an avoidance hole is provided in the bottom plate 10, and the main bdoy21 passes through the avoidance hole. The notches 11 are provided at the edge of the bottom plate 10, which means that the edge of the bottom plate 10 is recessed inward to form the notches 11. The avoidance hole is provided in the bottom plate 10, and can be located in the middle of the bottom plate 10, and the avoidance hole is a circumferentially closed hole structure.

By providing the notches 11 in the edge of the bottom plate 10, the main body 21 can pass through the bottom plate 10, and the main body 21 can be assembled from the edge of the bottom plate 10, which is more convenient for the installation of the main body 21. The main body 21 can be guided by the inner walls of the notches 11 or the inner wall of the avoidance hole to perform a linear motion. Alternatively, the avoidance hole can be defined in the bottom plate 10, so that the main body 21 can pass through the bottom plate 10, and the avoidance hole has a better guiding effect for the main body 21.

In one embodiment, two notches 11 are provided in the edge of the bottom plate 10, and the second connecting section 212 and the fourth connecting section 214 of the main body 21 pass through the two notches 11. Specifically, the side wall of the second connecting section 212 cooperates with the inner wall of the corresponding notch 11.

In one embodiment, two avoidance holes are provided in the bottom plate 10, and the second connecting section 212 and the fourth connecting section 214 of the main body 21 respectively pass through the two avoidance holes, and the inner walls of the two avoidance holes respectively limit the second connecting section 212 and the fourth connecting section 214 in the circumferential direction.

In one embodiment, in order to facilitate the installation of the main body 21, the third connecting section 213 can be separately provided from the second connecting section 212 and the fourth connecting section 214, and after the second connecting section 212 and the fourth connecting section 214 pass through the two avoidance holes, the opposite ends of the third connecting section 213 can be respectively connected to the second connecting section 212 and the fourth connecting section 214.

In one embodiment, referring to FIGS. 3 and 4, a washer 40 is disposed on the first side of the bottom plate 10 facing the threaded rod structure 30, and one end of the threaded rod structure 30 abuts against the washer 40. When the threaded rod structure 30 rotates, one end of the screw structure 30 always abuts against the washer 40.

By provision of the washer 40, the threaded rod structure 30 can be prevented from directly contacting the bottom plate 10, thereby protecting the bottom plate 10 from being scratched. In addition, the washer 40 is a consumable material. When the washer 40 has been worn out after long-term use, the washer 40 can be replaced to extend the service life of the robot.

In one embodiment, the washer 40 is fixed on the first side of the bottom plate 10 and stays stationary during rotation of the threaded rod structure.

In one embodiment, the washer 40 may be fixed to the bottom plate 10 by a screw, which facilitates the replacement of the washer 40. A connection hole is defined in the washer 40, and a connection hole is defined in the bottom plate 10. The screw passes through the connection hole on the washer 40 and is screwed into the connection hole in the bottom plate 10, so that the washer 40 is fixed to the bottom plate 10.

In one embodiment, referring to FIGS. 3 and 4, a screw 50 is fixed to the side of the threaded rod structure 30 facing the washer 40. A first through hole 12 is defined in the bottom plate 10, and a second through hole 41 is defined in the washer 40. The screw 50 passes through the first through hole 12 and the second through hole 41 and is threadedly connected to the lower end of the threaded rod structure 30. The screw 50 is provided with an external thread, and the screw 50 passes through the bottom plate 10 and the washer 40 and is threadedly connected to the threaded rod structure 30. When the threaded rod structure 30 rotates, the screw 50 rotates with the threaded rod structure 30, and the washer 40 and the bottom plate 10 remain stationary.

The threaded rod structure 30 is connected to the bottom plate 10 through the screw 50, so that the position of the threaded rod structure 30 can be limited, and the radial displacement of the threaded rod structure 30 can be prevented when the threaded rod structure 30 rotates, and the rotation of the threaded rod structure 30 will not be affected.

In one embodiment, the head of the screw 50 is located in the first through hole 12, so that the head of the screw 50 is hidden and does not affect the appearance of the robot.

In one embodiment, a countersink is defined in the side of the washer 40 facing the bottom plate 10, with the second through-hole 41 passing through the bottom of the countersink. Part of the head of the screw 50 is received in the countersink, which can serve to position the head of the screw 50 and prevent it from shifting.

In one embodiment, referring to FIGS. 3 and 4, the threaded structure 30 includes a threaded rod 31 and a rotary knob 32 fixed to one end of the threaded rod 31. The threaded rod 31 has an external thread threadedly engaged with the threaded hole 23, and the rotary knob 32 abuts against the bottom plate 10. The threaded rod 31 is threadedly connected to the clamping member 20, and the rotation of the threaded rod 31 drives the clamping member 20 to move linearly. When the rotary knob 32 rotates, it can drive the threaded rod 31 to rotate, which is more convenient for manual operation.

The knob 32 facilitates the rotation of the threaded rod 31 by the user, and the larger contact area between the rotary knob 32 and the clamping member 20 makes it less likely for the clamping member 20 to be scratched.

In one embodiment, a washer 40 is fixed to the first side of the bottom plate 10, and the knob 32 abuts against the washer 40.

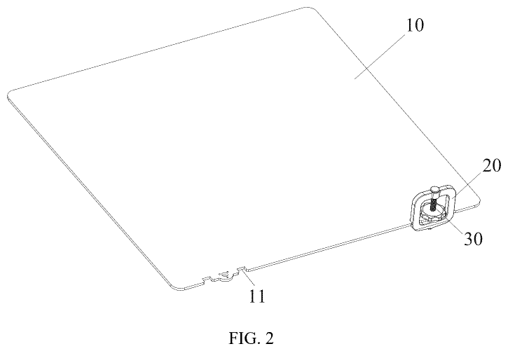

In one embodiment, referring to FIG. 2, multiple recesses 321 can be provided on the outer periphery of the knob 32, or a texture structure for increasing the surface roughness is provided.

When turning the knob 32, the recesses 321 facilitate the fingers to apply external force to the knob 32, and it is more convenient to manually rotate the knob 32. Alternatively, the texture structure increases the roughness of the outer periphery of the knob 32, preventing the fingers from slipping.

In one embodiment, the number of the recesses 321 is multiple, and they are sequentially arranged along the outer periphery of the knob 32.

In one embodiment, the textured structure can be in the form of striped protrusions, striped recesses, bumps, patterns, and so on.

Referring to FIG. 5, in one embodiment, the housing 101 further includes a side plate 60 connected to the bottom plate 10, and the side plate 60 is provided with a through hole 61 for exposing the knob 32. At least part of the knob 32 is exposed outside the housing 101. At least part of the knob 32 extends through the through hole 61.

By providing the through hole 61 in the side plate 60, the knob 32 can be at least partially exposed, making it convenient for the user to rotate the knob 32. This allows the knob 32 to be twisted from the outside.

As discussed above, the knob 32 is partially exposed outside the housing 101, which allows a user to simply operate the knob 32 to lock the robot to the desktop or unlock the robot from the desktop.

Referring to FIGS. 3 and 4, in one embodiment, the threaded rod 31 includes a head 311, a threaded shank 312 having an external thread, and a knob connecting section 313 fixedly connected to the knob 32, which are sequentially connected to one another. The threaded shank 312 is threadedly connected to the clamping member 20. The radius of the head 311 is greater than the radius of the threaded shank 312. Aa a result, the head 311 cannot pass through the threaded hole 23, and abuts against the upper end surface of the clamping member 20.

With such configuration of the threaded rod 31, not only can the threaded connection with the clamping member 20 be realized, but also the fixed connection with the knob 32 can be realized.

In one embodiment, the knob 32 is provided with a connecting hole, and the knob connecting section 313 is inserted into the connecting hole. The cross-section of the connecting hole and the cross-section of the knob connecting section 313 match each other, and the knob 32 and the knob connecting section 313 can be fixedly connected to each other by interference fit, welding, and the like.

In one embodiment, the connecting hole is a transmission hole, that is, when the knob 32 rotates, the knob connecting section 313 rotates synchronously with the knob 32. The cross section of the connecting hole is non-circular, such as D-shaped, C-shaped and oval.

Referring to FIG. 1, in one embodiment, multiple clamping members 20 and multiple threaded rod structures 30 can be employed. They can be arranged at intervals on the bottom plate 10. In this way, the multiple clamping members 20 cooperate with one another to clamp larger objects. Alternatively, each clamping member 20 clamps a different item, enhancing the functionality and versatility of the robot.

In one embodiment, when multiple clamping members 20 are employed, they can be sequentially spaced around the edge of the bottom plate 10.

The threaded rod structure 30 and at least a portion of the clamping member 20 are shielded by the housing, thereby improving the structural integrity of the robot and protecting the clamping member 20 and the threaded rod structure 30.

In one embodiment, when two clamping members 20 are employed, thumbs of both hands of a user can operate the knobs 32 simultaneously to lock the robot to the desktop or unlock the robot from the desktop. The knobs 32 can be configured in such a way that the thumbs of both hands of a user can rotate the knobs in the same or opposite directions simultaneously.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A desktop upper limb rehabilitation robot, comprising:
a housing having a bottom plate;
a clamping member comprising a main body slidably connected to the bottom plate and a jaw connected to the main body, the main body defining a threaded hole, the threaded hole and the jaw located at opposite sides of the bottom plate;
a threaded rod structure comprising a threaded rod, the threaded rod comprising an end rotatably connected to and abutting against the bottom plate, the threaded rod threadedly engaged with the threaded hole, and the threaded rod configured to rotate with respect to the bottom plate so as to drive the main body to move with respect to the bottom plate, allowing the jaw to move together with the main body to a desired position where an edge of a desk is sandwiched between the bottom plate and the jaw, which attaches the desktop upper limb rehabilitation robot to the desk.

2. The desktop upper limb rehabilitation robot of claim 1, wherein at least a portion of the threaded rod structure and at least a portion of the clamping member are located within the housing.

3. The desktop upper limb rehabilitation robot of claim 2, wherein the portion of the threaded rod structure is away from the jaw.

4. The desktop upper limb rehabilitation robot of claim 3, wherein the bottom plate defines one or more notches, and the main body passes through the one or more notches.

5. The desktop upper limb rehabilitation robot of claim 3, wherein the main body comprises a first connecting section, a second connecting section, a third connecting section, and a fourth connecting section that are connected to one another, forming a rectangular ring; the threaded hole is defined in the first connecting section, the jaw is connected to the third connecting section, and the second connecting section and the fourth connecting section passes through the bottom plate.

6. The desktop upper limb rehabilitation robot of claim 1, wherein the bottom plate comprises a washer facing the threaded rod structure, and the threaded rod abuts against the washer.

7. The desktop upper limb rehabilitation robot of claim 6, further comprising a screw passing through the bottom plate and the washer and fixed to the threaded rod.

8. The desktop upper limb rehabilitation robot of claim 1, wherein the threaded rod structure further comprises a rotary knob fixed to the threaded rod and abutting against the bottom plate.

9. The desktop upper limb rehabilitation robot of claim 8, wherein the housing further comprise a side plate connected to the bottom plate and defining a through hole, and the rotary knob partially passes through the through hole.

10. The desktop upper limb rehabilitation robot of claim 8, wherein the threaded rod comprises a threaded shank and a knob connecting section connected to the threaded shank, the threaded shank is threadedly engaged with the threaded hole, and the knob connecting section is connected to the rotary knob.
